(19) United States
(12) Patent Application Publication
(10) Pub. No.: US 2021/0201198 A1
(43) Pub. Date: Jul. 1, 2021

(54) METHOD, ELECTRONIC DEVICE, AND STORAGE MEDIUM FOR GENERATING NODE REPRESENTATIONS IN HETEROGENEOUS GRAPH

(71) Applicant: BEIJING BAIDU NETCOM SCIENCE AND TECHNOLOGY CO., LTD., Beijing (CN)

(72) Inventors: Weibin LI, Beijing (CN); Zhifan ZHU, Beijing (CN); Weiyue SU, Beijing (CN); Jingzhou HE, Beijing (CN); Shikun FENG, Beijing (CN); Yuhui CAO, Beijing (CN); Xuyi CHEN, Beijing (CN); Danxiang ZHU, Beijing (CN)

(21) Appl. No.: 16/945,183

(22) Filed: Jul. 31, 2020

(30) Foreign Application Priority Data
Dec. 26, 2019 (CN) 201911370733.3

(51) Int. Cl. G06N 20/00; G06F 16/901

(52) U.S. Cl. CPC G06N 20/00; G06F 16/9024

(57) ABSTRACT

A method for generating node representations in a heterogeneous graph, an electronic device, and a non-transitory computer-readable storage medium, and relates to the field of machine learning technologies. The method includes: acquiring a heterogeneous graph; inputting the heterogeneous graph into a heterogeneous graph learning model to generate a node representation of each node in the heterogeneous graph, in which the heterogeneous graph learning model generates the node representation of each node by actions of: segmenting the heterogeneous graph into a plurality of subgraphs, in which each subgraph includes nodes of two types and an edge of one type between the nodes of two types; and generating the node representation of each node according to the plurality of subgraphs.

### CROSS-REFERENCE TO RELATED APPLICATION

This application claims priority to Chinese Patent Application No. 201911370733.3, filed on Dec. 26, 2019, the entire contents of which are incorporated herein by reference.

### TECHNICAL FIELD

The disclosure relates to the fields of the Internet and machine learning technologies, and more particularly, to a method for generating node representations in a heterogeneous graph, an electronic device, and a non-transitory computer-readable storage medium.

### BACKGROUND

Real-world problems may be abstracted into graph models, i.e., collections of nodes and edges. For example, in a social platform, relations among a user and other users may be abstracted into a graph model. Each node in the graph model is represented by a vector, which is applicable for a variety of downstream tasks, such as node classification, link prediction, and community discovery.

Currently, in the node representation learning of the heterogeneous graph, different walk sequences are acquired through meta-path sampling. The walk sequences are regarded as sentence sequences, and trained through training methods such as word2vec, to acquire representations of graph nodes. In this way, the heterogeneous graph is trained as a homomorphic graph for training after meta-path sampling, and the structural information of the heterogeneous graph is lost, resulting in inaccuracy of the node representations generated finally.

### SUMMARY

In a first aspect, an embodiment of the disclosure provides a method for generating node representations in a heterogeneous graph. The method includes: acquiring a heterogeneous graph, in which the heterogeneous graph includes nodes of various types; and inputting the heterogeneous graph into a heterogeneous graph learning model to generate a node representation of each node in the heterogeneous graph, in which the heterogeneous graph learning model generates the node representation of each node by: segmenting the heterogeneous graph into a plurality of subgraphs, in which each subgraph includes nodes of two types and an edge of one type between the nodes of two types; and generating the node representation of each node according to the plurality of subgraphs.

In a second aspect, an embodiment of the disclosure provides an electronic device. The electronic device includes: at least one processor; and a memory connected in communication with the at least one processor. The memory stores instructions executable by the at least one processor. When the instructions are executed by the at least one processor, the at least one processor are caused to implement the above method.

In a third aspect, an embodiment of the disclosure provides a non-transitory computer-readable storage medium storing computer instructions. When the computer instructions are executed, a computer is caused to implement the above method.

Additional effects of the foregoing optional manners will be described below in combination with specific embodiments.

### BRIEF DESCRIPTION OF THE DRAWINGS

The accompanying drawings are used to better understand the solutions, and do not constitute a limitation on the disclosure, in which:

FIG. 1 is a flowchart of a method for generating node representations in a heterogeneous graph according to an embodiment of the disclosure.

FIG. 2 is an example diagram of segmenting a heterogeneous graph into a plurality of subgraphs according to edge types and node types.

FIG. 3 is an example diagram of a message passing process.

FIG. 4 is an example diagram of combining the same node in different subgraphs.

FIG. 5 is a flowchart of a method for generating node representations in a heterogeneous graph according to an embodiment of the disclosure.

FIG. 6 is a flowchart of a method for generating node representations in a heterogeneous graph according to an embodiment of the disclosure.

FIG. 7 is a block diagram of an apparatus for generating node representations in a heterogeneous graph according to an embodiment of the disclosure.

FIG. 8 is a block diagram of an apparatus for generating node representations in a heterogeneous graph according to an embodiment of the disclosure.

FIG. 9 is a block diagram of an electronic device for implementing a method for generating node representations in a heterogeneous graph according to an embodiment of the disclosure.

### DETAILED DESCRIPTION

The following describes the exemplary embodiments of the disclosure with reference to the accompanying drawings, which includes various details of the embodiments of the disclosure to facilitate understanding, and shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

A method and an apparatus for generating node representations in a heterogeneous graph and an electronic device are described below with reference to the drawings.

Real-world problems may be abstracted into graph models, i.e., collections of nodes and edges. From knowledge graphs to probability graph models, from protein interaction networks to social networks, from basic logic circuits to huge Internet, graphs and networks are everywhere.

There are a large number of heterogeneous graphs in the real-world. These heterogeneous graphs have various types of nodes and edges. Currently, in the node representation learning of the heterogeneous graph, the main method may be that: different walk sequences are acquired through meta-path sampling, and the walk sequences are regarded as sentence sequences and training methods such as word2vec are applied to train the walk sequences to acquire representations of graph nodes. In this way, the heterogeneous graph is trained as a homomorphic graph for training after meta-path sampling, and the structural information of the heterogeneous graph is lost, resulting in inaccuracy of the node representations generated finally.

In addition, for some learning methods, although different types of nodes are considered, and the types of nodes are distinguished in the representation learning of the heterogeneous graph, the entire adjacency matrix needs to be constructed for the heterogeneous graph when calculating the information transfer between adjacent nodes. When the number of nodes in the heterogeneous graph is large, the adjacency matrix constructed takes up a lot of storage space, making the calculation and storage of the entire adjacency matrix costly.

For the above problems, a method for generating node representations in a heterogeneous graph is provided, by segmenting the heterogeneous graph into the plurality of subgraphs according to the edge types and node types, and performing message aggregation training on each subgraph, the graph structural information under different edge types is acquired, the integrity of the structural information is ensured, and the accuracy of the node representations is improved, which is more conducive to the realization of downstream tasks. Moreover, by representing the nodes through the message passing mode to complete the node representations without constructing the entire adjacency matrix, the storage space required to store the adjacency matrix is reduced, and the cost of calculation and storage of the adjacency matrix is reduced.

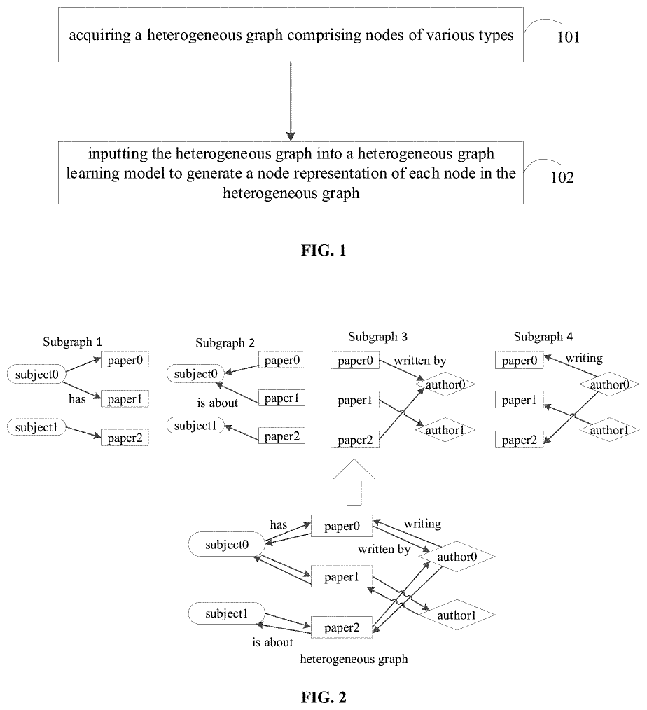

In detail, FIG. 1 is a flowchart of a method for generating node representations in a heterogeneous graph according to an embodiment of the disclosure. The method may be executed by an apparatus for generating node representations in a heterogeneous graph according to the disclosure, or may be executed by an electronic device, where the electronic device may be a server, or may be a terminal device such as a desktop computer, a notebook computer, which is not limited in the disclosure. The following takes the apparatus for generating node representations in the heterogeneous graph according to the disclosure performing the method for generating node representations in the heterogeneous graph according to the disclosure as an example to describe and explain the disclosure.

As illustrated in FIG. 1, the method for generating node representations in the heterogeneous graph includes the following actions.

At block 101, a heterogeneous graph is acquired, in which the heterogeneous graph includes nodes of various types.

Heterogeneous graphs can be selected according to the requirements of downstream tasks.

For example, if the downstream tasks are to recommend communities to users on the network platform, the heterogeneous graph may be a graph network constructed based on social behaviors of all users on the network platform, relations among the users, and relations between users and communities. The user's social behaviors may include, for example, published articles, comments of articles published by other users, and participating communities. The heterogeneous graph includes various types of nodes such as users, communities, articles, and comments.

At block 102, the heterogeneous graph is inputted into a heterogeneous graph learning model to generate a node representation of each node in the heterogeneous graph.

In the embodiment, by inputting the heterogeneous graph acquired into the heterogeneous graph learning model, the node representation of each node in the heterogeneous graph may be generated.

The heterogeneous graph learning model may generate the node representation of each node by the following actions.

Action 1: the heterogeneous graph is segmented into a plurality of subgraphs, in which each subgraph includes nodes of two types and an edge of one type between the nodes of two types.

Action 2: the node representation of each node is generated according to the plurality of subgraphs.

In this embodiment, when the heterogeneous graph learning model is used to generate the representation of each node in the heterogeneous graph, the inputted heterogeneous graph is segmented into the plurality of subgraphs according to the node types and edge types, and then the node representation of each node is generated based on the plurality of subgraphs.

It is understood that the number of subgraphs by segmenting the heterogeneous graph shall be consistent with the number of edge types.

For example, FIG. 2 is an example diagram of segmenting a heterogeneous graph into a plurality of subgraphs according to edge types and node types. In FIG. 2, the graph below is a complete heterogeneous graph, including three types of nodes and four types of edges, in which the three types of nodes are subject, paper, and author. The types of edges are subject-to-paper relation (has), paper-to-subject relation (is about), paper-to-author relation (written by), and author-to-paper relation (writing). Considering that the characteristics of different node types may be different, in order to learn the node representations of different node types, in this embodiment, the heterogeneous graph is segmented into four subgraphs according to the node types and edge types contained in the heterogeneous graph, as shown in FIG. 2. For the four subgraphs acquired by segmenting, the nodes in each of the subgraphs may be represented respectively, and then the node representation of each node is generated according to the plurality of subgraphs.

In the embodiment, when representing the nodes in each subgraph, characteristics of source nodes are transferred to target nodes in a message passing mode, and the characteristics of the source nodes may be used to represent the target nodes to generate node representations corresponding to the target nodes.

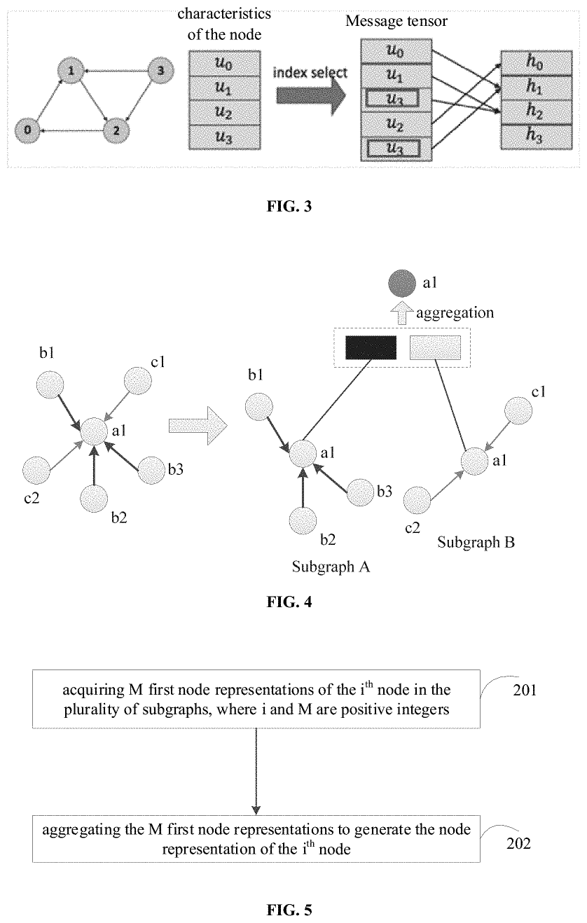

FIG. 3 is an example diagram of a message passing process. As illustrated in FIG. 3, the characteristics of each node in the subgraph are known and stored in advance in the storage space. In FIG. 3, u₀˜u₃ respectively represent the characteristics of nodes 0˜3. The corresponding characteristics are indexed according to the IDs of the source nodes in the subgraph to acquire a message tensor. The message tensor sends out the characteristics of the corresponding source nodes according to the distribution of the edges in the subgraph. Next, for each target node, node representations of the target nodes may be generated according to the characteristics of the corresponding source nodes. For example, for node 2, when node 2 is the target node, the source nodes are node 1 and node 3 correspondingly, and the node representation h₂ of node 2 is generated based on the characteristics u₁ of node 1 and the characteristics u₃ of node 3. In FIG. 3, h₀˜h₃ represent node representations of node 0˜node 3, respectively. It is seen from FIG. 3 that node 3 has no adjacent source nodes, then the representation of node 3 cannot be updated using the characteristics of the source nodes, and h₃ is its own characteristic u₃.

Because the heterogeneous graph is segmented into the plurality of subgraphs, the same node produces different representations in different subgraphs. For example, in FIG. 2, subgraph 1 and subgraph 4 both contain node paper0, but since the edge types of subgraph 1 and subgraph 4 are different, the node paper0 produces different representations in subgraph 1 and subgraph 4. In this embodiment, in order to combine information of different edge types, for each subgraph acquired by segmenting, after acquiring the representations of the nodes in the subgraph, a final node representation of each node may be generated according to the plurality of subgraphs.

In detail, for the same node, related message aggregation methods may be used to combine the representations of the node in different subgraphs. For example, the representations of the same node in different subgraphs are merged through matrix multiplication and the like to generate the final node representation of the node.

FIG. 4 is an example diagram of combining the same node in different subgraphs. As illustrated in FIG. 4, the heterogeneous graph in the left of FIG. 4 contains two edge types (represented by black lines and gray lines, respectively). According to these two edge types, the heterogeneous graph is segmented into two subgraphs, namely subgraph A and subgraph B in FIG. 4. In subgraph A, nodes b1˜b3 transfer their own characteristics to node a1, and the node representation of node a1 in subgraph A is generated. In subgraph B, nodes c1˜c2 transfer their own characteristics to node a1 to generate the node representation of node a1 in subgraph B. The two representations of node a1 in subgraph A and subgraph B may be aggregated to acquire the final representation of node a1 in the heterogeneous graph.

According to the method for generating node representations in the heterogeneous graph, the heterogeneous graph is acquired, and the heterogeneous graph is inputted into the heterogeneous graph learning model to generate the node representation of each node in the heterogeneous graph, in which the heterogeneous graph is segmented into the plurality of subgraphs, each subgraph includes the nodes of two types and the edge of one type between the nodes of two types, and the node representation of each node is generated according to the plurality of subgraphs. Therefore, by segmenting the heterogeneous graph into the plurality of subgraphs according to node types and edge types, and generating the node representation of each node based on the plurality of subgraphs, graph structural information with different edge types is acquired, and it is ensured that the structural information of the heterogeneous graphs is not lost, thus the integrity of the information of the nodes in the heterogeneous graph is guaranteed, and the accuracy of the node representations is improved.

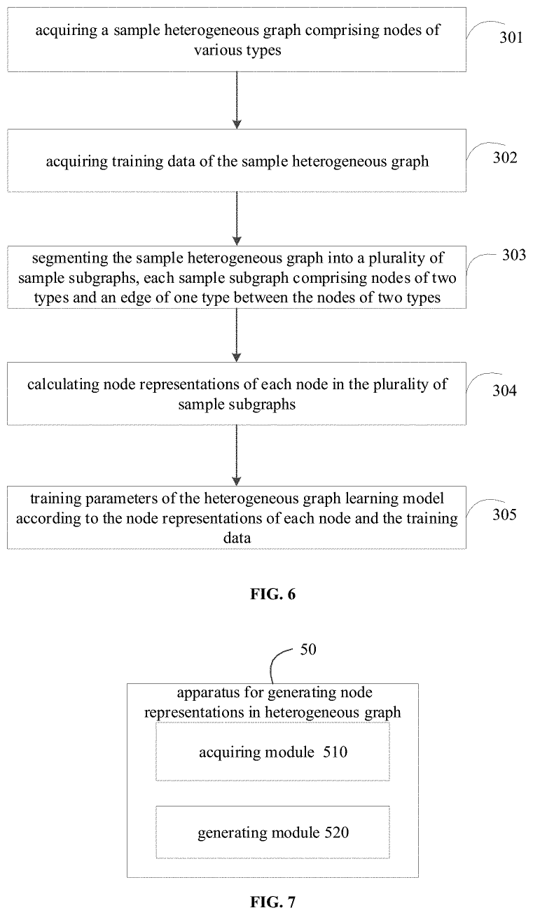

FIG. 5 is a flowchart of a method for generating node representations in a heterogeneous graph according to an embodiment of the disclosure. As illustrated in FIG. 5, according to the method for generating the node representations in the heterogeneous graph, generating the node representation of each node according to the plurality of subgraphs may include the following.

At block 201, M first node representations of the i^{th} node in the plurality of subgraphs are acquired, in which i and M are positive integers.

i represents the i^{th} node contained in the heterogeneous graph, i is a positive integer, and i^{th} is not greater than the total number of nodes contained in the heterogeneous graph; and the value of M is consistent with the number of subgraphs containing the i^{th} node.

As a possible implementation, when acquiring the M first node representations of the i^{th} node in the plurality of subgraphs, M subgraphs where the i^{th} node is located are acquired at first, and an adjacent node of the i^{th} node in the j^{th} subgraph may be acquired next, in which j is a positive integer less than or equal to M. Characteristics of the adjacent node are acquired to generate a first node representation of the i^{th} node in the j^{th} subgraph, and first node representations of the i^{th} node in other subgraphs of the M subgraphs are calculated sequentially. Thus, by acquiring the M subgraphs where the i^{th} node is located, the adjacent node of the i^{th} node in the j^{th} subgraph may be acquired, the characteristics of the adjacent node are acquired to generate the first node representation of the i^{th} node in the j^{th} subgraph, and the first node representations of the i^{th} node in other subgraphs of the M subgraphs are calculated sequentially, thereby achieving updating the node representations through message passing, acquiring the node representations in each subgraph without constructing the entire adjacency matrix, and acquiring the node representations under different edge types, which provides conditions for ensuring the integrity of the structural information, and reduces the storage space required to store the adjacency matrix and saving the storage cost.

In this embodiment, from the plurality of subgraphs acquired by segmenting, all subgraphs including the i^{th} node are acquired, and are denoted as M subgraphs. For each subgraph, the adjacent node of the i^{th} node in this subgraph may be acquired, the characteristics of the adjacent node are acquired, and the first node representation of the i^{th} node in this subgraph is generated by using the characteristics of the adjacent node. For the M subgraphs, the first node representation of the i^{th} node in each subgraph is calculated in the above manner to acquire the M first node representations of the i^{th} node.

At block 202, the M first node representations are aggregated to generate the node representation of the i^{th} node.

Thus, by acquiring the M first node representations of the i^{th} node in the plurality of subgraphs respectively, and aggregating the M first node representations to generate the node representation of the i^{th} node, the first node representations of the same node under different edge types may be combined together, the node representations of the node under different edge types may be realized, and the integrity of the structural information is guaranteed.

In this embodiment, after acquiring the M first node representations of the i^{th} node in the M subgraphs, a related aggregation algorithm may be used to aggregate the M first node representations to generate the node representation of the i^{th} node in the heterogeneous graph.

According to the method for generating the node representations in the heterogeneous graph of this embodiment, the M first node representations of the i^{th} node in the plurality of subgraphs are acquired, and the M first node representations are aggregated to generate the node representation of the i^{th} node, thus, the first node representations of the same node under different edge types are combined together, the node representations of the node under different edge types may be realized, and the integrity of the structural information is guaranteed.

In the embodiments of the disclosure, in order to be able to use the heterogeneous graph learning model to generate the node representation of each node in the heterogeneous graph, the heterogeneous graph learning model needs to be trained first, and detailed description on the training process of the heterogeneous graph learning model is provided below in combination with FIG. 6.

FIG. 6 is a flowchart of a method for generating node representations in a heterogeneous graph according to an embodiment of the disclosure. As illustrated in FIG. 6, in the embodiment of the disclosure, the training process of the heterogeneous graph learning model includes the following.

At block 301, a sample heterogeneous graph is acquired, in which the sample heterogeneous graph includes nodes of various types.

At block 302, training data of the sample heterogeneous graph is acquired.

As a possible implementation, the training data of the sample heterogeneous graph may be acquired by meta-path sampling.

For each sample heterogeneous graph, the corresponding metapath is defined in advance, and then the training data of the sample heterogeneous graph is acquired according to the defined metapath, i.e., according to sampling order defined by the metapath and serial number of the sampling nodes.

The training data includes but is not limited to IDs of the nodes to be sampled.

At block 303, the sample heterogeneous graph is segmented into a plurality of sample subgraphs, in which each sample subgraph includes nodes of two types and an edge of one type between the nodes of two types.

In this embodiment, the sample heterogeneous graph may be segmented according to the node types and edge types contained in the sample heterogeneous graph, and the sample heterogeneous graph may be segmented into the plurality of sample subgraphs.

At block 304, node representations of each node in the plurality of sample subgraphs are calculated.

In this embodiment, after the sample heterogeneous graph is segmented into the plurality of sample subgraphs, for each sample subgraph, the node representation of each node in the sample subgraph may be calculated.

It is noted that, when calculating the node representation of each node in the sample subgraph, the node representation of the node may be updated by using the characteristics of the adjacent node of the node. For the specific process, reference may be made to the message passing process shown in FIG. 3, which is not repeated herein.

At block 305, parameters of the heterogeneous graph learning model are trained according to the node representations of the node and the training data.

In this embodiment, when training the parameters of the heterogeneous graph learning model, the node representation corresponding to the ID of the node to be sampled in the training data may be indexed from the node representation of each node according to the training data, and the node representations are used to train the parameters of the heterogeneous graph learning model and to update the parameters of the heterogeneous graph learning model.

For example, for the heterogeneous graph and each subgraph shown in FIG. 2, assuming that the defined metapath is “subject-paper-author-paper-subject”, the training data may include IDs of nodes in subgraph “subject-paper”, subgraph “paper-author”, subgraph “author-paper” and subgraph “paper-subject”, and then when training the parameters of the heterogeneous graph learning model, according to the training data, the subgraph “subject-paper” is sampled at first, and then the subgraph “paper-author”, the subgraph “author-paper”, and the subgraph “paper-subject” are sampled sequentially, the node representation of each node in each subgraph is acquired, and the node representation of each node is used to represent the parameters of the heterogeneous graph learning model for training.

Thus, by acquiring the sample heterogeneous graph and the training data of the sample heterogeneous graph, the sample heterogeneous graph is segmented into the plurality of sample subgraphs, each sample subgraph includes the nodes of two types and the edge of one type between the nodes of two types, the node representations of each node in the plurality of sample subgraphs may be calculated, and then the parameters of the heterogeneous graph learning model are trained according to the node representations of each node and the training data to achieve the message aggregation training by segmenting the sample heterogeneous graph into the plurality of sample subgraphs according to the edge types and node types, which acquires the graph structural information under different edge types, ensures the integrity of the structural information, and is more conducive to the realization of downstream tasks. Moreover, by representing the nodes through the message passing mode to complete the node representations without constructing the entire adjacency matrix, the storage space required to store the adjacency matrix is reduced.

As a possible implementation, the parameters of the heterogeneous graph learning model can be trained according to the node representations of each node and the training data through the skipgram algorithm (gradient descent algorithm). Therefore, with the skipgram algorithm, an unsupervised learning technique, less content is required to be memorized by the model, which is conducive to simplifying the training process.

It is understandable that the process of training the parameters of the heterogeneous graph learning model is an iterative process. By calculating the objective function of the heterogeneous graph learning model, the parameters of the heterogeneous graph learning model are continuously updated until the heterogeneous graph learning model is converged and the model training is complete.

Embodiments in the disclosure has the following advantages or beneficial effects.

The heterogeneous graph is acquired, and the heterogeneous graph is inputted into the heterogeneous graph learning model to generate the node representation of each node in the heterogeneous graph, in which the heterogeneous graph is segmented into the plurality of subgraphs, each subgraph includes the nodes of two types and the edge of one type between the nodes of two types, and the node representation of each node is generated according to the plurality of subgraphs. Therefore, by segmenting the heterogeneous graph into the plurality of subgraphs according to node types and edge types, and generating the node representation of each node based on the plurality of subgraphs, graph structural information with different edge types is acquired, and it is ensured that the structural information of the heterogeneous graphs is not lost, thus the integrity of the information of the nodes in the heterogeneous graph is guaranteed, and the accuracy of the node representations is improved. By segmenting the heterogeneous graph into the plurality of subgraphs according to node types and edge types, and generating the node representation of each node based on the plurality of subgraphs, the characteristic information corresponding to nodes of each edge type may retained, such that it may ensure that the structural information of the heterogeneous graph is not lost, and the integrity of the information of the nodes in the heterogeneous graph is ensured, thereby improving the accuracy of the node representations, and solving the technical problems in the related art that the heterogeneous graph is trained as the homomorphic graph for training through meta-path sampling, resulting in loss of the structural information of the heterogeneous graph, and the inaccuracy of the generated node representations.

According to embodiments of the disclosure, an apparatus for generating node representations in a heterogeneous graph is provided.

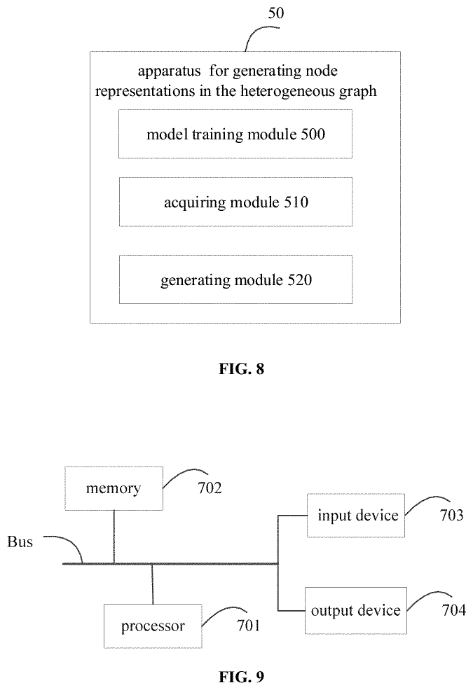

FIG. 7 is a block diagram of an apparatus for generating node representations in a heterogeneous graph according to an embodiment of the disclosure. As illustrated in FIG. 7, the apparatus 50 for generating the node representations in the heterogeneous graph includes: an acquiring module 510 and a generating module 520.

The acquiring module 510 is configured to acquire a heterogeneous graph, in which the heterogeneous graph includes nodes of various types.

The generating module 520 is configured to input the heterogeneous graph into a heterogeneous graph learning model to generate a node representation of each node in the heterogeneous graph, in which the heterogeneous graph learning model generates the node representation of each node by: segmenting the heterogeneous graph into a plurality of subgraphs, each subgraph including nodes of two types and an edge of one type between the nodes of two types; and generating the node representation of each node according to the plurality of subgraphs.

Further, in a possible implementation of the embodiments of the disclosure, the generating module 520 uses the heterogeneous graph learning model to generate the node representation of each node based on the plurality of subgraphs, specifically including: acquiring M first node representations of the i^{th} node in the plurality of subgraphs, where i and M are positive integers; and; and aggregating the M first node representations to generate the node representation of the i^{th} node.

M subgraphs where the i^{th} node is located are acquired at first, and an adjacent node of the i^{th} node in the j^{th} subgraph may be acquired next, in which j is a positive integer less than or equal to M. Characteristics of the adjacent node are acquired to generate a first node representation of the i^{th} node in the j^{th} subgraph, and first node representations of the i^{th} node in other subgraphs of the M subgraphs are calculated sequentially.

In a possible implementation of the embodiment of the disclosure, as shown in FIG. 8, on the basis of the embodiment shown in FIG. 7, the apparatus for generating node representations in a heterogeneous graph further includes: a model training module 500. The model training module 500 is configured to: acquire a sample heterogeneous graph including nodes of various types; acquire training data of the sample heterogeneous graph; segment the sample heterogeneous graph into a plurality of sample subgraphs, each sample subgraph including nodes of two types and an edge of one type between the nodes of two types; calculate node representations of each node in the plurality of sample subgraphs; and train parameters of the heterogeneous graph learning model according to the node representations of each node and the training data.

In a possible implementation, the model training module 500 is configured to train the parameters of the heterogeneous graph learning model by skipgram algorithm according to the node representations of each node and the training data.

It is noted that the foregoing explanation and description of the embodiments of the method for generating the node representations in the heterogeneous graph is also applicable for the apparatus for generating the node representations in the heterogeneous graph in the embodiments of the disclosure, and the implementation principle is similar, which is not repeated herein.

According to the apparatus for generating the node representations in the heterogeneous graph, the heterogeneous graph is acquired, and the heterogeneous graph is inputted into the heterogeneous graph learning model to generate the node representation of each node in the heterogeneous graph, in which the heterogeneous graph is segmented into the plurality of subgraphs, each subgraph includes the nodes of two types and the edge of one type between the nodes of two types, and the node representation of each node is generated according to the plurality of subgraphs. Therefore, by segmenting the heterogeneous graph into the plurality of subgraphs according to node types and edge types, and generating the node representation of each node based on the plurality of subgraphs, graph structural information with different edge types is acquired, and it is ensured that the structural information of the heterogeneous graphs is not lost, thus the integrity of the information of the nodes in the heterogeneous graph is guaranteed, and the accuracy of the node representations is improved.

According to the embodiments of the disclosure, the disclosure also provides an electronic device and a readable storage medium.

FIG. 9 is a block diagram of an electronic device for implementing the method for generating the node representations in the heterogeneous graph according to an embodiment of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the electronic device includes: one or more processors 701, a memory 702, and interfaces for connecting various components, including high-speed interfaces and low-speed interfaces. The various components are interconnected using different buses and can be mounted on a common mainboard or otherwise installed as required. The processor 701 may process instructions executed within the electronic device, including instructions stored in or on the memory 702 to display graphical information of the GUI (Graphical User Interface) on an external input/output device such as a display device coupled to the interfaces. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 701 is taken as an example in FIG. 9.

The memory 702 is a non-transitory computer-readable storage medium according to the disclosure. The memory 702 stores instructions executable by at least one processor, so that the at least one processor 701 executes the method for generating node representations in a heterogeneous graph according to the disclosure. The non-transitory computer-readable storage medium of the disclosure stores computer instructions, which are used to cause a computer to execute the method for generating node representations in a heterogeneous graph according to the disclosure.

As a non-transitory computer-readable storage medium, the memory 702 is configured to store non-transitory software programs, non-transitory computer executable programs and modules, such as program instructions/modules corresponding to the method for generating node representations in a heterogeneous graph in the embodiment of the disclosure (For example, the acquiring module 510 and the generating module 520 shown in FIG. 7). The processor 701 executes various functional applications and data processing of the server by running non-transitory software programs, instructions, and modules stored in the memory 702, that is, implementing the method for generating node representations in a heterogeneous graph in the foregoing method embodiment.

The memory 702 may include a storage program area and a storage data area, where the storage program area may store an operating system and application programs required for at least one function. The storage data area may store data created according to the use of the electronic device for performing the method for generating node representations in a heterogeneous graph, and the like. In addition, the memory 702 may include a high-speed random-access memory, and a non-transitory memory, such as at least one magnetic disk storage device, a flash memory device, or other non-transitory solid-state storage device. In some embodiments, the memory 702 may optionally include a memory remotely disposed with respect to the processor 701, and these remote memories may be connected to the electronic device through a network. Examples of the above network include, but are not limited to, the Internet, an intranet, a local area network, a mobile communication network, and combinations thereof.

The electronic device for implementing the method for generating node representations in a heterogeneous graph may further include an input device 703 and an output device 704. The processor 701, the memory 702, the input device 703, and the output device 704 may be connected through a bus or in other manners. In FIG. 9, the connection through the bus is taken as an example.

The input device 703 may receive inputted numeric or character information, and generate key signal inputs related to user settings and function control of an electronic device, such as a touch screen, a keypad, a mouse, a trackpad, a touchpad, an indication rod, one or more mouse buttons, trackballs, joysticks and other input devices. The output device 704 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general-purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (For example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (egg, a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other.

It should be understood that the various forms of processes shown above can be used to reorder, add, or delete steps. For example, the steps described in the disclosure can be executed in parallel, sequentially, or in different orders, as long as the desired results of the technical solutions disclosed in the disclosure can be achieved, which is no limited herein.

The foregoing specific implementations do not constitute a limitation on the protection scope of the present application. It should be understood by those skilled in the art that various modifications, combinations, sub-combinations, and substitutions may be made according to design requirements and other factors. Any modification, equivalent replacement and improvement made within the spirit and principle of the disclosure shall be included in the protection scope of the disclosure.

What is claimed is:

1. A method for generating node representations in a heterogeneous graph, comprising:
acquiring a heterogeneous graph comprising nodes of various types; and
inputting the heterogeneous graph into a heterogeneous graph learning model to generate a node representation of each node in the heterogeneous graph, the heterogeneous graph learning model generating the node representation of each node by the following actions:
segmenting the heterogeneous graph into a plurality of subgraphs, each subgraph comprising nodes of two types and an edge of one type between the nodes of two types; and
generating the node representation of each node according to the plurality of subgraphs.

2. The method according to claim 1, wherein the generating the node representation of each node according to the plurality of subgraphs comprises:
acquiring M first node representations of the ith node in the plurality of subgraphs, where i and M are positive integers; and
aggregating the M first node representations to generate the node representation of the i^{th} node.

3. The method according to claim 2, wherein the acquiring the M first node representations of the i^{th} node in the plurality of subgraphs, comprises:
acquiring M subgraphs where the i^{th} node is located;
acquiring an adjacent node of the i^{th} node in the i^{th} subgraph, where j is a positive integer less than or equal to M; and
acquiring characteristics of the adjacent node to generate a first node representation of the i^{th} node in the j^{th} subgraph, and sequentially calculating first node representations of the i^{th} node in other subgraphs of the M subgraphs.

4. The method according to claim 1, wherein the heterogeneous graph learning model is generated by the following actions:
acquiring a sample heterogeneous graph comprising nodes of various types;
acquiring training data of the sample heterogeneous graph;
segmenting the sample heterogeneous graph into a plurality of sample subgraphs, each sample subgraph comprising nodes of two types and an edge of one type between the nodes of two types;
calculating node representations of each node in the plurality of sample subgraphs; and
training parameters of the heterogeneous graph learning model according to the node representations of each node and the training data.

5. The method according to claim 4, wherein the parameters of the heterogeneous graph learning model are trained by skipgram algorithm according to the node representations of each node and the training data.

6. An electronic device, comprising:
at least one processor; and
a memory connected in communication with the at least one processor; wherein,
the memory stores instructions executable by the at least one processor, and when the instructions are executed by the at least one processor, the at least one processor are caused to implement a method for generating node representations in a heterogeneous graph, the method comprising:
acquiring a heterogeneous graph comprising nodes of various types; and
inputting the heterogeneous graph into a heterogeneous graph learning model to generate a node representation of each node in the heterogeneous graph, the heterogeneous graph learning model generating the node representation of each node by the following actions:
segmenting the heterogeneous graph into a plurality of subgraphs, each subgraph comprising nodes of two types and an edge of one type between the nodes of two types; and
generating the node representation of each node according to the plurality of subgraphs.

7. The electronic device according to claim 6, wherein the generating the node representation of each node according to the plurality of subgraphs comprises:
acquiring M first node representations of the i^{th} node in the plurality of subgraphs, where i and M are positive integers; and
aggregating the M first node representations to generate the node representation of the i^{th} node.

8. The electronic device according to claim 7, wherein the acquiring the M first node representations of the i^{th} node in the plurality of subgraphs, comprises:
acquiring M subgraphs where the i^{th} node is located;
acquiring an adjacent node of the i^{th} node in the i^{th} subgraph, where j is a positive integer less than or equal to M; and
acquiring characteristics of the adjacent node to generate a first node representation of the i^{th} node in the j^{th} subgraph, and sequentially calculating first node representations of the i^{th} node in other subgraphs of the M subgraphs.

9. The electronic device according to claim 6, wherein the heterogeneous graph learning model is generated by the following actions:
acquiring a sample heterogeneous graph comprising nodes of various types;
acquiring training data of the sample heterogeneous graph;
segmenting the sample heterogeneous graph into a plurality of sample subgraphs, each sample subgraph comprising nodes of two types and an edge of one type between the nodes of two types;
calculating node representations of each node in the plurality of sample subgraphs; and
training parameters of the heterogeneous graph learning model according to the node representations of each node and the training data.

10. The electronic device according to claim 9, wherein the parameters of the heterogeneous graph learning model are trained by skipgram algorithm according to the node representations of each node and the training data.

11. A non-transitory computer-readable storage medium storing computer instructions, wherein when the computer instructions are executed, a computer is caused to implement a method for generating node representations in a heterogeneous graph, the method comprising:
acquiring a heterogeneous graph comprising nodes of various types; and
inputting the heterogeneous graph into a heterogeneous graph learning model to generate a node representation of each node in the heterogeneous graph, the heterogeneous graph learning model generating the node representation of each node by the following actions:
segmenting the heterogeneous graph into a plurality of subgraphs, each subgraph comprising nodes of two types and an edge of one type between the nodes of two types; and
generating the node representation of each node according to the plurality of subgraphs.

12. The non-transitory computer-readable storage medium according to claim 11, wherein the generating the node representation of each node according to the plurality of subgraphs comprises:
acquiring M first node representations of the ith node in the plurality of subgraphs, where i and M are positive integers; and
aggregating the M first node representations to generate the node representation of the i^{th} node.

13. The non-transitory computer-readable storage medium according to claim 12, wherein the acquiring the M first node representations of the i^{th} node in the plurality of subgraphs, comprises:
acquiring M subgraphs where the i^{th} node is located;
acquiring an adjacent node of the i^{th} node in the i^{th} subgraph, where j is a positive integer less than or equal to M; and
acquiring characteristics of the adjacent node to generate a first node representation of the i^{th} node in the j^{th} subgraph, and sequentially calculating first node representations of the i^{th} node in other subgraphs of the M subgraphs.

14. The non-transitory computer-readable storage medium according to claim 11, wherein the heterogeneous graph learning model is generated by the following actions:
acquiring a sample heterogeneous graph comprising nodes of various types;
acquiring training data of the sample heterogeneous graph;
segmenting the sample heterogeneous graph into a plurality of sample subgraphs, each sample subgraph comprising nodes of two types and an edge of one type between the nodes of two types;
calculating node representations of each node in the plurality of sample subgraphs; and
training parameters of the heterogeneous graph learning model according to the node representations of each node and the training data.

15. The non-transitory computer-readable storage medium according to claim 14, wherein the parameters of the heterogeneous graph learning model are trained by skipgram algorithm according to the node representations of each node and the training data.
